(19) United States
(12) Patent Application Publication
(10) Pub. No.: US 2018/0039761 A1
(43) Pub. Date: Feb. 8, 2018

(54) METHOD AND SYSTEM FOR AUTOMATICALLY ADDING CONNECTORS DURING GENERATION OF A REPORT

(71) Applicant: Algotec Systems Ltd., Rochester, NY (US)

(72) Inventors: Christopher M. Gaskin, Keswick, VA (US); Menashe Benjamin, Ra'anana (IL); Yinon Aradi, Ra'anana (IL)

(21) Appl. No.: 15/667,653

(22) Filed: Aug. 3, 2017

Related U.S. Application Data
(60) Provisional application No. 62/371,260, filed on Aug. 5, 2016.

(51) Int. Cl. G06F 19/00; G06F 17/30

(52) U.S. Cl. CPC G06F 19/3487; G06F 17/30014

(57) ABSTRACT

A system and method for automatically adding connectors, for example through insertion, to a medical report. The connectors may optionally be added after the medical report is generated but are preferably adding while the medical report is being generated, so that medical personnel can review the addition of such connectors during medical report generation.

### CROSS REFERENCE TO RELATED APPLICATIONS

This application claims the benefit of U.S. Provisional application U.S. Ser. No. 62/371,260, provisionally filed on Aug. 5, 2016, entitled “METHOD AND SYSTEM FOR AUTOMATICALLY ADDING CONNECTORS DURING GENERATION OF A REPORT”, in the names of Benjamin et al., which is incorporated herein in its entirety.

### FIELD OF THE INVENTION

The invention relates to a system and method for automatically adding connectors during generation of a report and particularly, but not exclusively, to adding such connectors during generation of a medical report that features medical images.

### BACKGROUND OF THE INVENTION

Medical image software has become a diagnostic tool. Such software allows skilled medical personnel, such as doctors, to view, manipulate and interact with medical images such as CT (computerized tomography) scans, MRI (magnetic resonance imaging) scans, PET (positron emission tomography) scans, mammography scans and the like. As the amount of information that radiologists are forced to handle increases, so is the time spent on each study. In addition, the number of studies a radiologist needs to review is increasing as well. This can cause a bottleneck in interpreting and reporting studies for further follow-up by the referring physicians. Therefore, radiologists desire to accurately and rapidly interact with medical image processing software and ultimately, to be able to report and share their results in as short and efficient a time as possible so as to speed up patient care.

Part of the medical image diagnostic process involves the radiologist's report. Current reporting software varies between voice recognition systems to reports being dictated into a dictation device for later typing by a skilled typist, to reports being typed by the radiologist (or doctor or other trained personnel) or dictated by telephone to medical personnel. A common feature of the above methods is that all of them take place while the radiologist or other trained personnel is viewing dedicated reporting software. This software is installed on a radiology reporting station, either in parallel to the review software (such as a PACS [Picture Archiving And Communication System] viewer or dedicated workstation) or integrated into the PACS viewer itself such as in native reporting on Carestream's Vue PACS.

However the report itself is much more useful when the medical images are present. For example, if other medical personnel wish to review the report then the text alone may not present a complete picture; it is better to review the report while also reviewing the medical images to which the report makes reference. Therefore, medical personnel need access to both text and images.

Having easy access to images with the report can also speed up the process of review, for example when more than one radiologist/doctor reviews and/or adds to a medical image diagnostic report before it is considered to be finalized, for example when a resident's report needs to be reviewed by a more senior doctor, or when a second opinion is requested, the results of which are then to be incorporated into a final report. If the images are not easily accessed with the text, this can slow down the process of review, as everyone reading the report needs to also have access to the images, regardless of the original source or location of these images.

US2014/0006926 to Yeluri et al describes a system for connecting report text to external content.

US2010/0138241 to Ruark et al describes a system for automatically reviewing medical records to determine whether they include sufficient diagnostic documentation.

US2014/0142939 to Aradi et al describes a system for automatically creating medical report text from dictation.

US2010/0114597 to Shreiber et al describes a system for extracting medical data from one source for embedding in a medical report.

US2012/0131436 to Leontiev et al describes a system for allowing a user to select a link in a medical report and then to view the image corresponding to that link.

US2014/0344701 to Shreiber describes a system for providing image based report correction.

US2014/0278554 to Mabotuwana and Qian describes a system for using image references in radiology reports to support report-to-image navigation.

### SUMMARY OF THE INVENTION

There is therefore a need for system and method for automatically adding one or more connectors during generation of a report, which may be used for example to connect the report to an external resource.

The present invention, in at least some embodiments, provides a system and method for automatically adding one or more connectors, for example through insertion, to a medical report to connect the report to one or more external data sources (although reference may be made herein to a single data source, it is understood that optionally connectors may connect to one or more such data sources). Optionally, the report is a medical report and the connectors connect the report to an external data source, which is optionally and preferably one or more medical images. A connector may optionally be any type of address or pointer which provides direction to the external data source, including but not limited to hyperlinks. Although reference may be made herein to a single connector, it is understood that optionally a plurality of connectors may be added.

The connectors may optionally be added after the medical report is generated through text analysis but are preferably added while the medical report is being generated, so that medical personnel can review the addition of such connectors during medical report generation.

Without wishing to be limited by a closed list, such connectors are useful when generating a medical report as they integrate smoothly with the flow of report generation. As a non-limiting example, the workflow of reporting for a radiologist is much more efficient when the reviewing system (PACS) and reporting system are integrated, such that the reporting system is preferably aware of which images and studies the radiologist is reviewing at any given time while the report is being dictated. Using this knowledge allows the system to place connectors to the images that the radiologist is reviewing but is only possible if the image review system and report system are integrated.

According to at least some embodiments, the connectors are in the form of hyperlinks from the text to the one or more medical images being referenced. It should be noted that optionally multiple images may be inserted as a set of images or a “study” of images (optionally with a single hyperlink or multiple hyperlinks), and/or as multiple such sets or studies. Optionally each set or study would have a separate hyperlink. The hyperlinks are preferably placed in the text in a relevant location; for example, when the user states a trigger word, such as “insert prior” or some type of statement. Alternatively or additionally, a hyperlink may optionally be automatically inserted when the user starts to access a new external data source, such as a study comprising one or more medical images. Also alternatively or additionally, a hyperlink may optionally be automatically inserted when the user pushes a button (or interacts with another mechanical interface) and/or interacts with a user computer interface in some way, for example by clicking on or otherwise selecting a GUI (graphical user interface) gadget or widget. Optionally any of these actions may be considered as a “trigger”.

The determination of the relevant location of the text is preferably made automatically, according to the trigger as described herein. In the case of the trigger, optionally the image (or a hyperlink or other connector to same) is inserted at the location of the cursor.

If instead the connectors, such as the hyperlinks, are added after the text has been generated or otherwise created, then optionally the text is analyzed for a trigger, for example and without limitation, a trigger as a word in the text, some type of verbal cue (extraneous to the words being dictated) and/or some type of signal that is external to the text (for example, the press of a button or other indicator by the person dictating). The text analysis process analyzes the text and searches for relevant keywords or key phrases, which indicate that a connector may optionally be added to the report, optionally in real time but alternatively after report generation. For example, the text analysis process may optionally search for the trigger phrase “insert prior”, or any other suitable trigger word or phrase. The text analysis process may optionally be performed according to any suitable text analysis technology; one of ordinary skill in the art could easily select such a technology. One non-limiting example of such a technology is described in U.S. Ser. No. 14/278,580 to Shreiber, owned in common with the present application, which is hereby incorporated by reference as if fully set forth herein.

Next the external data source is identified. The external data source may optionally be identified according to any suitable process. Preferably however it is identified by determining which external data source is being accessed at a particular point in dictating the report, for example according to when the user carries out the trigger operation, for example as previously described, and the set of images and/or studies that are opened by the image review system at the time, for example that are opened by the PACS. Again as noted previously, by “external data source” it is optionally meant a plurality of data sources.

A connector, such as a hyperlink, is then added to connect the report to the identified external data source or sources. Optionally and preferably a plurality of such connectors is used as previously described.

Such a connection may optionally be made in various ways. When the radiologist carries out the trigger operation, for example as previously described, the connector may optionally be inserted at that point (or some predefined point). The new text may look like this for example: Comparison to studies: Apr. 7, 2009; Mar. 24, 2005; Jun. 8, 2001.

Each of these dates may optionally be marked also by a hyperlink such that pressing that hyperlink causes the PACS (or other integrated image review software) to launch and show the images for the study of that date.

Optionally the report can be viewed in two ways, for example through the reporting software that is integrated into the PACS. In that case, pressing the hyperlink shows the images in the PACS. The second method is by viewing it from an altogether external system (e.g. viewing the text in the EMR, viewing a pdf file, and the like). In those cases, the hyperlink may optionally link to an image viewer, such as a zero footprint image viewer (such as for example Vue Motion of Carestream Health, Inc.) which is launched and shows the images.

A user, such as a medical professional, may optionally be given the opportunity to review each insertion of connectors to external data sources within the text, and to accept, amend or reject each such insertion.

According to at least some embodiments, as embedded in the text, the connectors may optionally include some type of identification of the external data source(s) to which connection is made. For example and without limitation, if the external data source is a medical image study, then the appearance of the connector in the text may optionally include the date of the medical image study. Additionally or alternatively, the appearance of the connector in the text may optionally include a modality, body part, study description (for example according to the DICOM definitions) and/or other description of the external data source.

Without wishing to be limited to a closed list, the system and method as described herein saves time both in dictation and in the review process, by clearly indicating which external data source(s) are relevant to a particular medical report. For example, a single patient may have one or more irrelevant studies that a medical professional could potentially access. By clearly connecting a point in the text to one or more relevant studies for comparison, through an automatic process based on what the radiologist reviewed while dictating the report, the system and method as described herein can eliminate irrelevant information and reduce errors in making such connections.

According to at least some embodiments, capabilities are provided remotely to the user's computer, and may optionally be provided through a “zero footprint” application running from an internet or web browser on the user's computer (software for displaying mark-up language documents, for example according to HTML).

According to at least some further embodiments, the system provides for storage of the connected text report along with the medical images.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 shows an exemplary, illustrative system according to at least some embodiments of the present invention for automatically connecting a relevant location in a report to a relevant external data source, for example according to a trigger operation.

FIG. 2 shows an exemplary, illustrative method according to at least some embodiments of the present invention for adding one or more connectors to external data sources for medical information.

FIG. 3 shows an additional exemplary, illustrative method according to at least some embodiments of the present invention for adding one or more connectors to external data sources in connection with generation of dictated text.

FIG. 4 shows an exemplary, illustrative completed report according to at least some embodiments of the present invention.

### DESCRIPTION OF EMBODIMENT OF THE INVENTION

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a tablet, a PDA (personal digital assistant), or a pager. Any two or more of such devices in communication with each other may optionally comprise a “computer network”.

Although the present description centers around medical image data, it is understood that the present invention may optionally be applied to any suitable three dimensional image data, including but not limited to computer games, graphics, artificial vision, computer animation, biological modeling (including without limitation tumor modeling) and the like.

At least some embodiments of the present invention are now described with regard to the following illustrations and accompanying description, which are not intended to be limiting in any way.

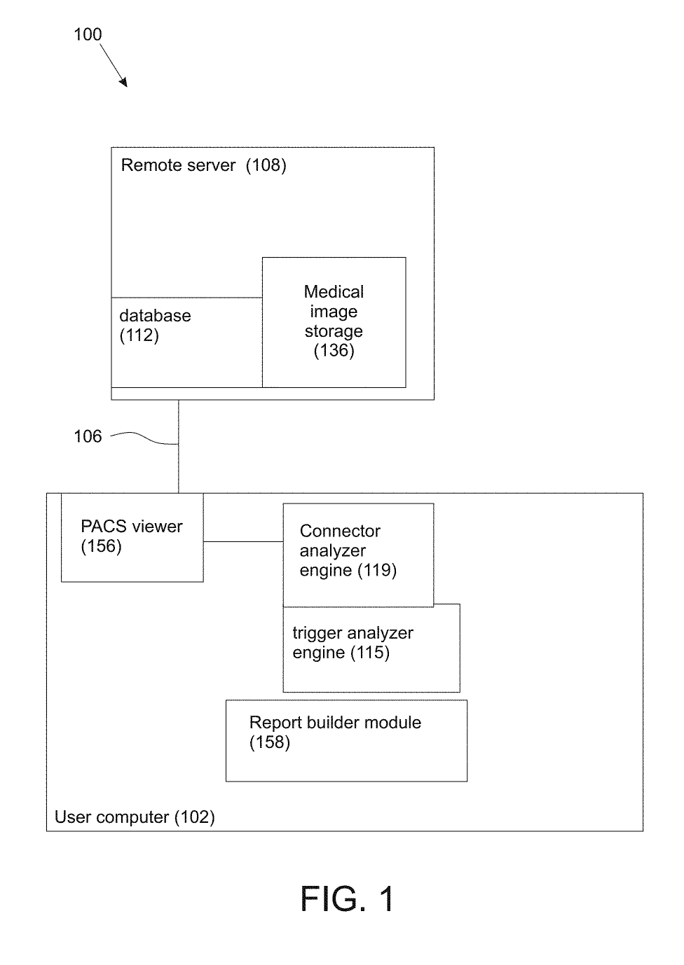

FIG. 1 shows an exemplary, illustrative system according to at least some embodiments of the present invention for voice to text reporting for medical image software. As shown, a system 100 features a user computer 102, which is in communication with a remote server 108 through a computer network 106. Computer network 106 may optionally be any type of computer network, such as the Internet for example. To promote security, computer network 106 preferably features at least a security overlay, such as a form of HTTPS (secure HTTP) communication protocol, or any type of security overlay to the communication protocol, such as 256-bit SSL3 AES and security certificates for example, and may also optionally feature a VPN (virtual private network) in which a secure “tunnel” is effectively opened between user computer 102 and remote server 108.

It should be noted that remote server 108 may optionally comprise a plurality of processors and/or a plurality of computers and/or a plurality of virtual machines, as is known in the art.

Remote server 108 optionally and preferably operates a medical image processing software, shown herein as PACS module 110, although any suitable medical image processing software may optionally be provided, for example which operates according to DICOM (Digital Imaging and Communications in Medicine). PACS module 110 may optionally comprise any type of medical image processing software or a combination of such softwares. Remote server 108 optionally and preferably provides a PACS server or a DICOM archive. Remote server 108 stores the medical images in storage 136 and also comprises a database 112 for holding medical image data.

PACS module 110 optionally queries the database for studies, retrieves studies from the storage to be sent to the client for review processes medical image data, for example allowing images to be segmented or otherwise analyzed; supporting “zoom in-zoom out” for different magnifications or close-up views of the images; cropping, highlighting and so forth of the images.

PACS module 110 preferably communicates with a PACS viewer module 156, which is provided on user computer 102 as shown. PACS viewer module 156 features some or all of the functionality of PACS module 110 for image processing, analysis and manipulation. In at least some embodiments, PACS viewer module 156 performs many if not all of the functions of PACS module 110 for viewing and manipulating images. The user operating user computer 102 may therefore optionally change one or more of the images through local processing by PACS viewer module 156 on user computer 102 as shown. PACS viewer module 156 may also optionally feature its own image database (not shown).

Alternatively, PACS module 110 may optionally perform many if not all of these functions, such that PACS viewer module 156 may optionally be implemented as a “thin client”, for example on a web browser, optionally even up to a zero footprint software.

Such complete support for remote medical image viewing and analysis is known in the art, and is in fact provided by the Vue Motion product currently being offered as part of Carestream Health offerings. All of these examples relate to examples of “thin clients”, with low or “zero” footprints on user computer 102, preferably provided through a web browser but optionally provided through other software.

User computer 102 preferably features a trigger analyzer engine 115 and a connector analyzer engine 119 as shown. Trigger analyzer engine 115 detects the presence of a trigger, which as previously described may optionally be having an image or set of images being displayed, and/or a trigger initiated by the user, for example a mechanical trigger, a GUI trigger and/or a trigger involving a word or phrase, whether spoken or written.

Optionally trigger analyzer engine 115 analyzes verbal (spoken) words to detect the presence of a trigger word or phrase.

Optionally trigger analyzer engine 115 is implemented as a text analyzer which analyzes text of a medical report, whether after generation or as it is generated, to locate one or more relevant keywords or key phrases, which act as trigger words or trigger phrases, that indicate that a connector may optionally be added to the report. The connector is optionally and preferably added at, about or near the timing or location of the keyword or key phrase, which optionally may or may not be present in the report itself.

For example, the text analysis process performed by trigger analyzer engine 115 may optionally search for the word “insert prior” which acts as a trigger phrase. The text analysis process may optionally be performed according to any suitable text analysis technology; one of ordinary skill in the art could easily select such a technology. One non-limiting example of such a technology is described in U.S. Ser. No. 14/278,580 to Shreiber, owned in common with the present application, which is hereby incorporated by reference as if fully set forth herein.

Next the external data source (or set of such data sources) is identified optionally according to any suitable process. For example, the external data source is optionally and preferably identified according to the external data source that is being viewed and/or that was previously loaded by the medical professional at the time that the trigger operation was performed.

A connector analyzer engine 119 preferably is in communication with PACS viewer 156, in order to determine which medical image(s) and/or group(s) of images, such as a medical image study for example, is being viewed. Of course a different software interface may optionally be operated by user computer 102 for viewing or otherwise accessing other external data sources (not shown), in which case such a software interface would also be in communication with connector analyzer engine 119, again to determine which external data source is being viewed at the time that the trigger operation was performed.

A connector, such as a hyperlink, is then added to connect the location in the report as previously described, to the identified external data source according to its location by connector analyzer engine 119. For example, a hyperlink could connect a location in the report when the medical professional mentions the trigger word or phrase to the group of medical image(s) designated as “Study 1” for that particular patient, if in fact the medical professional is viewing “Study 1” at that time. A date or other information may also optionally be used, additionally or alternatively. Additionally or alternatively, the appearance of the connector may optionally include other descriptive information related to the external data source, such as a body part, modality, study description, for example according to the DICOM definitions, for a medical image study.

The appearance of the connector may optionally relate to the appearance in the text of the report. For example and without limitation, if the connector is a hyperlink, then optionally the words highlighted or otherwise included in the hyperlink may be described as the “appearance of the connector”. For example for a hyperlink to an external medical study, the words included in the hyperlink may optionally include some type of description of the external medical study, including but not limited to a number of the study (in terms of the order in which the studies were performed), the data on which the study was performed and/or a body part, and/or modality, study description on which the study was performed and that may be taken from various meta-data stored with the study such as from the DICOM tags of the study.

For example, a doctor may be reading lumbar spine MRI, but may use the abdominal CT sagittal reformats as a comparison. This would clarify that the study was compared to an abdominal CT, rather than a dedicated lumbar spine CT, which might be implied if the connector appearance only included the modality and date. Instead of “CT Mar. 31, 2014” it might say “CT abdomen Mar. 31, 2014”. This appearance of the connector could optionally be configured to user or site preference, where the configuration parameters include which meta data fields to include in the appearance of the connector.

Other optional embodiments which may be implemented include having connector analyzer engine 119 automatically determine which external data source is being accessed, each time that a new data source is accessed, and to automatically insert a connector. Optionally such automatic placement is performed if the trigger operation occurs at the beginning of the report and/or at any time after the trigger operation takes place during the reporting session.

Alternatively, such automatic placement is performed even if the trigger operation occurs at the end of the report, as connector analyzer engine 119 may optionally keep track of the place in the report where the medical professional views the external data source. For example, the insertion may optionally be performed at a fixed position in the report, such as including a comparison section at the beginning or other location in the report, which could then for example optionally include a list of studies. In such a situation, the user may optionally trigger inclusion of such a section at any time, before, during or after report generation.

Preferably, connector analyzer engine 119 is connected to PACS viewer 156 as the text of the medical report is generated. Also preferably connector analyzer engine 119 is connected to trigger analyzer engine 115 as the text of the medical report is generated. Such medical report text generation may optionally be performed at a report builder module 158, which in turn provides the text to trigger analyzer engine 115 for analysis as previously described.

A user, such as a medical professional, may optionally be given the opportunity to review each connector placement within the text, and to accept, amend or reject each such placement. The user may optionally be given the opportunity to review each identification of an external data source related to trigger word(s) or trigger phrase(s), and to accept, amend or reject each such identification. Optionally, such an opportunity is provided by displaying one or more parts of the medical report, optionally in conjunction with the one or more external data sources referenced, to the user, for example through report builder module 158. The user may also optionally edit the report itself, the trigger word or trigger phrase reference(s) and/or the location of the external data source(s) through report builder module 158.

Once the user is satisfied that the text is correct and the appropriate connectors have been included and the report is therefore complete, the user optionally and preferably “signs off” or otherwise indicates the report's completed state through report builder module 158. This information is then transmitted to remote server 108, which optionally and preferably stores a copy of the report in database 112 and/or in a separate DICOM archive such as in storage 136, more preferably along with an indication of the report's connection to various images. Optionally the report is distributed to additional systems such as a Radiology Information System or in a Hospital Information System.

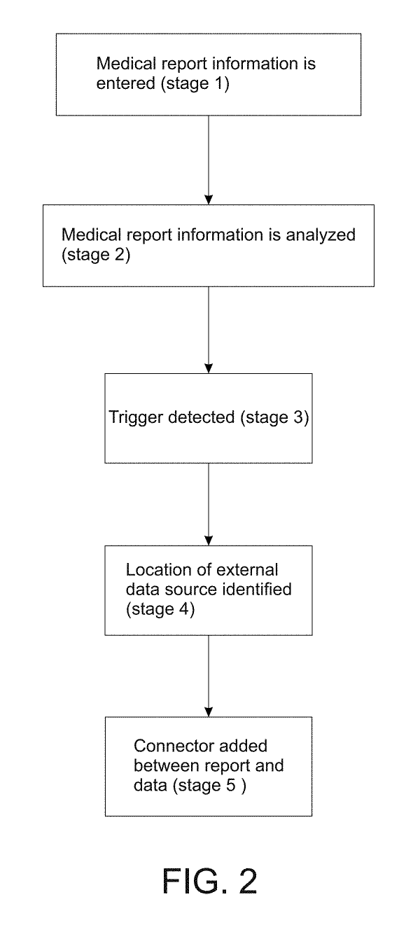

FIG. 2 shows an exemplary, illustrative method according to at least some embodiments of the present invention for adding connectors to external data sources during generation of dictated text.

As shown, in stage 1, medical report information is entered; for example and without limitation, the user may optionally dictate a medical report by voice.

In stage 2, optionally as the information is entered, the information is analyzed; for example and without limitation, voice to text generation is performed to generate text. In stage 3, a trigger is detected as previously described, which indicates that a connector to an external data source, such as a group of medical images, is to be inserted. Optionally the trigger operation may be pressing a button or performing some action which is external to the entry and/or analysis of medical information.

In stage 4, the external data source (or set of sources) is located according to the external data source that is being viewed by the user at that time, for example by viewing a group of medical images, and/or that were previously loaded. In stage 5, a connection is made between the report and the external data source, optionally to a plurality of such data sources and optionally with a plurality of connectors. Preferably such a connection is made by inserting a connector into the report at a specific location as previously described.

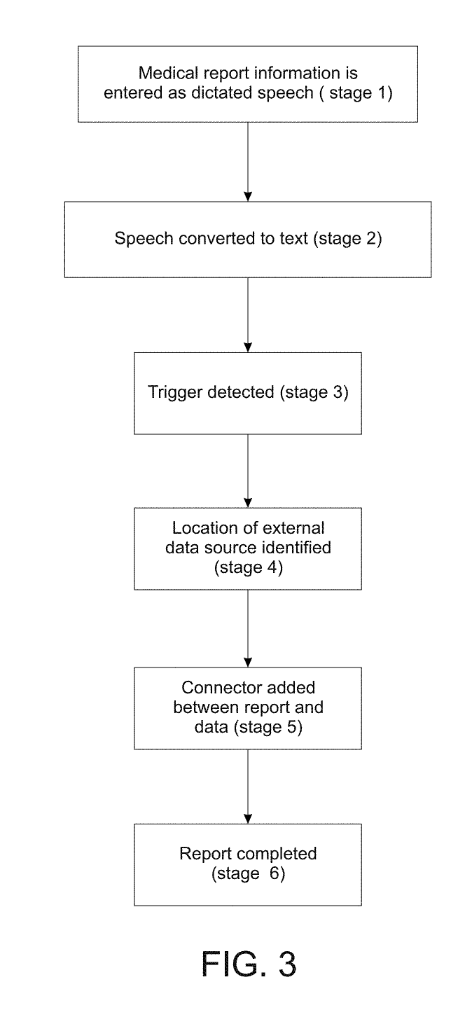

FIG. 3 shows an exemplary, illustrative implementation for another type of medical information analysis according to at least some embodiments of the present invention. This implementation of the method optionally features the trigger analyzer engine as a text analyzer engine for the purpose of description only and without any intention of being limiting.

As shown in FIG. 2, medical information is optionally entered in stage 1 as dictated speech. In stage 2, the dictated speech is optionally converted to text with a voice to text engine for generating text from voice dictation, thereby permitting the analysis of the text for identification of one or more trigger words or trigger phrases to be performed during voice dictation. Voice to text engine may optionally be any such engine which is known in the art, including but not limited to such engines that are available from Nuance (for example and without limitation, the 360 SpeechAnywhere platform). Voice to text engine may also optionally be in data communication with a dictionary, which may optionally and preferably comprise specialized medical terms, of the type that are likely to be of interest or needed for dictating a medical image diagnostic report.

Next in stage 3, a trigger is optionally identified. For example, such identification may optionally occur when the text is analyzed with a trigger word/trigger phrase identifier for identifying the relevant trigger word(s) or trigger phrase(s) that indicate that a connection is to be made to an external data source. Optionally, trigger word/trigger phrase identifier uses the dictionary to identify important trigger words and/or trigger phrases, which are optionally and preferably flagged or otherwise indicated in dictionary.

For example, trigger words such as “insert prior” are preferably included in dictionary. The trigger may optionally be any type of word or other identifier, not just a word or phrase, as previously described.

As another non-limiting example, the trigger may also optionally be detected by the speech recognition platform, for example through an API.

The method then optionally continues as for stages 4 and 5 of the method of FIG. 2.

Various implementations are optionally possible in terms of completing the report and including the connectors in stage 6. As a non-limiting example, the voice to text engine then transmits back a text report to the user, optionally with the relevant trigger word(s) or trigger phrase(s) marked for user review (optionally with the identification of the external data source). The converted text is preferably transmitted back for viewing as the user dictates or is at least transmitted back intermittently, such that the user views dictated text in near real time. Alternatively, the text is transmitted back when the user completes their dictation. As another non-limiting example, stage 6 is not performed.

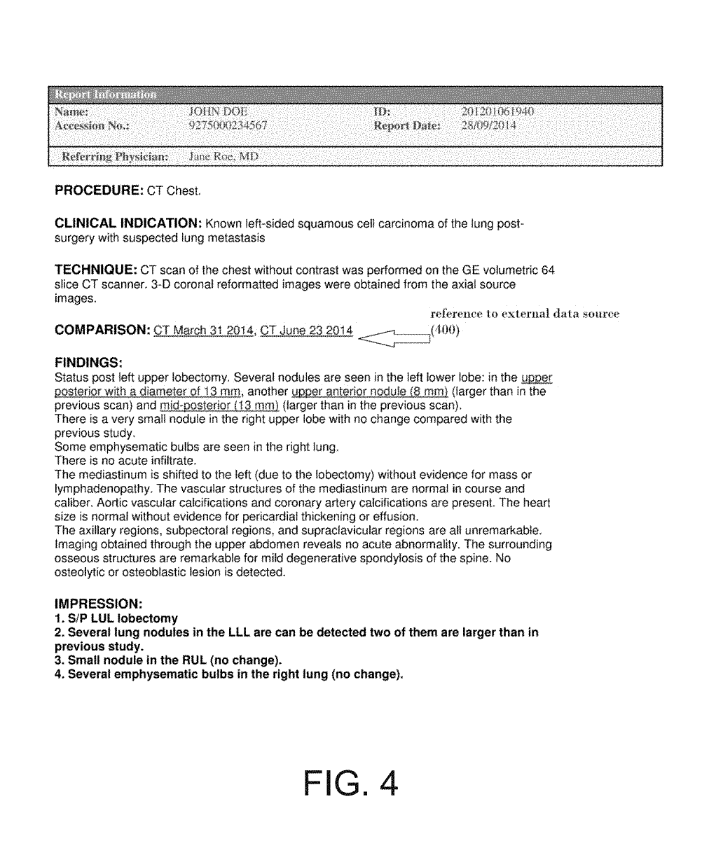

FIG. 4 shows an exemplary, illustrative completed report according to at least some embodiments of the present invention. As shown, an exemplary completed report features links to an external data resource 400, which in this non-limiting example is a plurality of previously performed medical image studies. Optionally the text indicated by the hyperlink, for example by a differential text appearance, includes a study type and date as shown, and/or an indication of a body part, modality, study description that is the subject of the study (not shown).

Although the present description centers around interactions with medical image data, it is understood that the system may be applied to any suitable three dimensional image data, including but not limited to computer games, graphics, artificial vision, computer animation, biological modeling (including without limitation tumor modeling) and the like.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for adding a connector in a medical report to an external data source, the medical report being generated through a user computer, the method comprising:
automatically determining an external data source according to access through the user computer;
detecting a trigger indicating that a connector is to be added; and
adding a connector to the report according to the external data source being accessed through the user computer before or during the detecting the trigger.

2. The method of claim 1, wherein the external data source comprises at least one study of medical images and wherein the adding the connector comprises connecting the report to the study of medical images through a hyperlink.

3. The method of claim 2, wherein the detecting the trigger comprises detecting an interaction with the user computer.

4. The method of claim 3, wherein the user computer operates a GUI (graphical user interface) and wherein the detecting the interaction comprises detecting an interaction with the GUI.

5. The method of claim 4, wherein the adding the connector further comprises determining a location in the medical report to add the connector, wherein the determining the location comprises detecting a location of a cursor or other indicator through the user computer when the trigger is detected.

6. The method of claim 2, further comprising generating the medical report through entering text to the user computer and wherein the detecting the trigger comprises detecting a word or phrase in the text.

7. The method of claim 6, wherein the entering the text comprises dictating the text.

8. The method of claim 6, wherein the adding the connector further comprises determining a location in the medical report to add the connector, wherein the determining the location comprises detecting a location of a cursor or other indicator in the text being entered to the user computer.

9. The method of claim 2, wherein the detecting the trigger comprises receiving an input through the user computer.

10. The method of claim 2, wherein automatically determining the external data source comprises determining the external data source according to one or more studies that were loaded or viewed to or through the user computer.

11. The method of claim 2, wherein the connecting the report to the study of medical images through the hyperlink comprises adjusting at least one aspect of an appearance of the hyperlink according to at least one parameter of the study.

12. The method of claim 11, wherein the at least one aspect of the appearance comprises text included within the hyperlink.

13. The method of claim 12, wherein the text included within the hyperlink has a different visual indication from a remainder of text in the medical report.

14. The method of claim 13, wherein the different visual indication comprises highlighting.

15. The method of claim 12, wherein the at least one parameter comprises a date on which the study was conducted and the text included within the hyperlink includes the date.

16. The method of claim 12, wherein the study comprises a plurality of studies, and wherein the at least one parameter comprises a numerical identifier indicating when the study was performed and the text included within the hyperlink includes the numerical identifier.

17. The method of claim 12, wherein the at least one parameter comprises a body part, modality, study description or any other combination of DICOM tags on which the study was conducted and the text included within the hyperlink includes the DICOM tags.

18. The method of claim 12, wherein the at least one parameter comprises a body part on which the study was conducted and a date on which the study was conducted, and the text included within the hyperlink includes the body part and the date.
